(19) United States
(12) Patent Application Publication
(10) Pub. No.: US 2013/0144491 A1
(43) Pub. Date: Jun. 6, 2013

(54) TECHNIQUE FOR CONTROLLING LANE MAINTENANCE BASED ON DRIVER'S CONCENTRATION LEVEL

(71) Applicant: Jae Hee Kim, Seoul (KR)

(72) Inventor: Jae Hee Kim, Seoul (KR)

(73) Assignee: HYUNDAI MOTOR COMPANY, Seoul (KR)

(21) Appl. No.: 13/449,474

(22) Filed: Apr. 18, 2012

(30) Foreign Application Priority Data
Dec. 6, 2011 (KR) 10-2011-0129736

(51) Int. Cl. B62D 6/00

(52) U.S. Cl. 701/42

(57) ABSTRACT

Provided is a technique which controls lane maintenance based on a driver's concentration level. More specifically, for a memory stores reference steering angles for each driver's concentration level. Each of the reference steering angles indicates time points that a lane keeping assist system (LKAS) intervenes in driving. A calculator calculates a driver's concentration level based on a variation of a steering angle and a driving state of a vehicle. A controller detects a reference steering angle corresponding to a calculated concentration level from the calculator based on the reference steering angles for each driver's concentration level stored in the memory, and controls an LKAS driver based on a detected reference steering angle. The LKAS driver drives the LKAS based on the detected reference steering angle from the controller.

### CROSS-REFERENCES TO RELATED APPLICATIONS

Priority to Korean patent application number 10-2011-0129736, filed on Dec. 6, 2011, which is incorporated by reference in its entirety, is claimed.

### BACKGROUND OF THE INVENTION

1. Field of the Invention

The present invention relates to a technique for controlling lane maintenance based on a driver's concentration level, and more particularly, to an apparatus for controlling lane maintenance based on a driver's concentration level which aides in safe driving while securing a driver's steering control by applying differently when a lane keeping assist system (LKAS) intervenes, and a method thereof.

2. Description of the Related Art

A lane keeping assist system (LKAS) receives lane and position information from a lane detection camera mounted on a vehicle, and aids the driver in maintaining the vehicle within the desired lane of travel by generating a steering torque that prevents the vehicle from moving out of its lane unintentionally.

Conventional LKAS devices are operated based on a time point of intervention which is set by a driver. Unfortunately, when the driver sets the intervention time to be delayed, there may still be occasions in which the LKAS should intervene but does not due to the driver's setting. On the contrary if the intervention time is reduced too much, the LKAS may make it difficult for the driver to intentionally change lanes, thereby annoying the driver and causing strain on steering control of the vehicle. Thus, since the LKAS of the prior art is operated based on an intervention time point set according to taste of a driver, this system cannot dynamically secure a driver's steering control and stably preventing lane departure.

### SUMMARY OF THE INVENTION

The present invention has been made in view of the above problems, and provides an apparatus for controlling lane maintenance based on a driver's concentration level which not only supports safe driving, but also secures dynamic steering control by applying a torque differently when a lane keeping assist system (LKAS) intervenes based on a driver's concentration level, and a method thereof.

In accordance with an aspect of the present invention, an apparatus for controlling lane maintenance based on a driver's concentration level includes: a memory configured to store reference steering angles for each driver's concentration level, each of the reference steering angles indicating time points when a lane keeping assist system (LKAS) intervenes in driving. The apparatus also includes a calculator that is configured to calculate a concentration level of a driver based on a variation of a steering angle and a driving state of a vehicle. A controller detects a reference steering angle corresponding to a calculated concentration level from the calculator based on the reference steering angles for each driver's concentration level stored in the memory, and controls an LKAS driver based on a detected reference steering angle. The LKAS driver drives the LKAS based on the detected reference steering angle from the controller.

In accordance with another aspect of the present invention, an apparatus for controlling lane maintenance based on a driver's concentration level includes: a collector that collects information about a concentration level of a driver. A controller controls a lane keeping assist system (LKAS) driver at a first reference steering angle by determining that the concentration level of the driver is low when the driver's concentration information collector collects the concentration level of the driver, and controls the LKAS driver at a second reference steering angle by determining that the driver's concentration level of the driver is high when the collector does not collect the concentration level of the driver. The LKAS driver drives an LKAS based on either the first or second reference steering angle received from the controller.

In accordance with another aspect of the present invention, a method for controlling lane maintenance based on a driver's concentration level includes: storing reference steering angles for each driver's concentration level within a memory, each of the reference steering angle indicating time points that a lane keeping assist system (LKAS) intervenes in driving; calculating a concentration level of a driver based on a variation in a steering angle and a driving state of a vehicle by a calculator; detecting a reference steering angle correspond to a calculated concentration level based on the reference steering angles corresponding to each stored concentration level by a controller; and driving the LKAS based on the detected reference steering angle by an LKAS driver.

In accordance with another aspect of the present invention, a method for controlling lane maintenance based on a driver's concentration level includes: collecting information about a concentration level of a driver by a collector; controlling, by a controller, a lane keeping assist system (LKAS) driver at a first reference steering angle by determining that the concentration level of the driver is low when the driver's concentration information collector collects the concentration level of the driver; controlling, by the controller, the LKAS driver at a second reference steering angle by determining that the concentration level of the driver is high when the collector does not collect the concentration level of the driver; and driving an LKAS based on either the first or second reference steering angle from the controller by the LKAS driver.

### BRIEF DESCRIPTION OF THE DRAWINGS

The objects, features and advantages of the present invention will be more apparent from the following detailed description in conjunction with the accompanying drawings, in which:

FIG. 1 is a block diagram illustrating an apparatus for controlling lane maintenance based on a driver's concentration level according to an exemplary embodiment of the present invention;

FIG. 2 is a view for explaining reference steering angles for each driver's concentration level according to an exemplary embodiment of the present invention;

FIG. 3 is a block diagram illustrating a configuration of a driver's concentration level calculator according to an exemplary embodiment of the present invention;

FIG. 4 is a flowchart for explaining a process of calculating a driver's concentration level by a driver's concentration level calculator according to an exemplary embodiment of the present invention;

FIG. 5 is a flowchart for explaining a method for controlling lane maintenance based on a driver's concentration level according to an exemplary embodiment of the present invention; and

FIG. 6 is a flowchart for explaining a method for controlling lane maintenance based on a driver's concentration level according to another exemplary embodiment of the present invention.

### DETAILED DESCRIPTION OF EXEMPLARY EMBODIMENTS

Exemplary embodiments of the present invention are described with reference to the accompanying drawings in detail. The same reference numbers are used throughout the drawings to refer to the same or like parts. Detailed descriptions of well-known functions and structures incorporated herein may be omitted to avoid obscuring the subject matter of the present invention.

It is understood that the term “vehicle” or “vehicular” or other similar term as used herein is inclusive of motor vehicles in general such as passenger automobiles including sports utility vehicles (SUV), buses, trucks, various commercial vehicles, watercraft including a variety of boats and ships, aircraft, and the like, and includes hybrid vehicles, electric vehicles, combustion, plug-in hybrid electric vehicles, hydrogen-powered vehicles and other alternative fuel vehicles (e.g. fuels derived from resources other than petroleum).

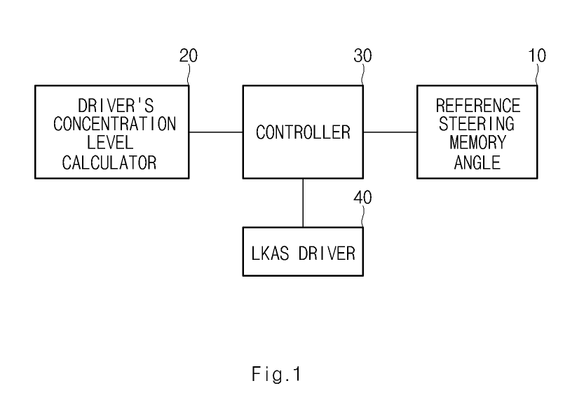

FIG. 1 is a block diagram illustrating an apparatus for controlling lane maintenance based on a driver's concentration level according to one embodiment of the present invention. As illustrated in FIG. 1, an apparatus for controlling lane maintenance based on a driver's concentration level according to the present invention includes a memory, i.e., reference steering angle memory 10, a calculator, i.e., a driver's concentration level calculator 20, a controller 30, and a lane keeping assist system (LKAS) driver 40. Each of the above-mentioned structural elements will be described below.

The reference steering angle memory 10 stores reference steering angles which indicate time points at which an LKAS intervenes in driving based on each driver's concentration level. That is, the reference steering angle memory 10 stores one reference steering angle at which an intervention time point of the LKAS is delayed when the driver's concentration level is high, and another reference steering angle at which the intervention time point of the LKAS is shortened when the driver's concentration level is low.

Hereinafter, the reference steering angle according to the present invention will be described in more detail.

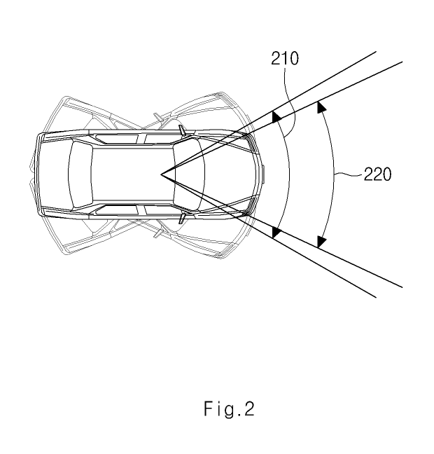

As depicted in FIG. 2, a reference numeral ‘210’ denotes the first reference steering angle which is applied when the driver's concentration level is high and reference numeral ‘220’ denotes the second reference steering angle which is applied when the driver's concentration level is low. That is, when the driver's concentration level is high, the first reference steering angle is a wide angle and is applied so that the driver's steering control is maximized. And, when the driver's concentration level is low, the second reference steering angle is a narrow angle and is applied so that lane departure of a vehicle is stably prevented.

For example, the reference steering angles according to one exemplary embodiment of the driver's concentration levels are presented in Table 1 as an example. However, the present invention is not limited thereto.

TABLE 1

| Driver's concentration level | Reference steering angle |
|---|---|
| 1 | 15°~−15° |
| 2 | 17°~−17° |
| 3 | 19°~−19° |
| 4 | 21°~−21° |
| 5 | 23°~−23° |

In Table 1, the reference steering angle has a positive angle in the left direction and a negative angle in the right direction with reference to a straightaway (i.e., ‘0’ degrees) of a vehicle.

The driver's concentration level calculator 20 calculates the driver's concentration level based on a variation in a steering angle and a driving state of a vehicle. The driver's concentration level calculator 20 calculates an index which is used for determining the driver's concentration level, based on variations in the steering angle of the vehicle while it is being driven and information about the driving state of the vehicle obtained through a front camera sensor. The calculator 20 converts a calculation result into statistical information to calculate the driver's concentration level. This will be described in detail below.

The controller 30 detects a reference steering angle corresponding to a calculated concentration level calculated by the calculator 20, based on the reference steering angles for each driver's concentration level stored in the memory 10, and controls the LKAS driver 40 based on a detected reference steering angle. That is, the controller 30 transfers the detected reference steering angle to the LKAS 40 to allow the LKAS driver 40 to set detected reference steering angle as a reference for driving the LKAS. The LKAS driver 40 drives the LKAS based on the detected reference steering angle from the controller 30 when a steering angle of the vehicle deviates from the reference steering angle.

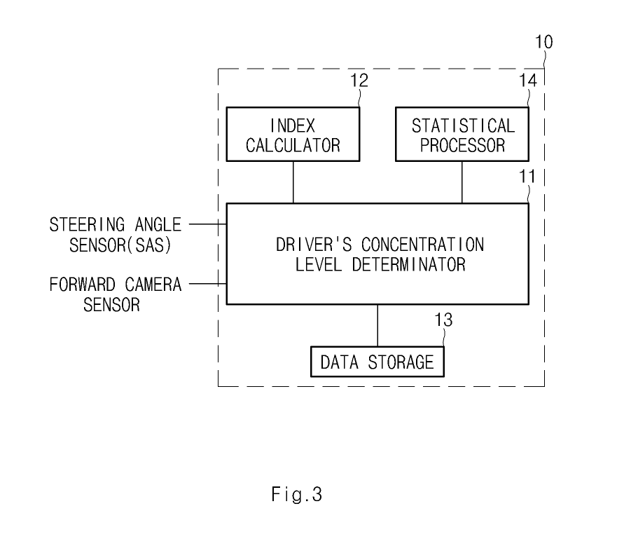

Hereinafter, the driver's concentration level calculator 20 according to the present invention will be described in detail with reference to FIG. 3.

FIG. 3 is a block diagram illustrating a configuration of the driver's concentration level calculator 20 according to an exemplary embodiment of the present invention. Referring to FIG. 3, a driver's concentration level determinator 11 determines the driver's concentration level based on a sensed signal of a steering angle sensor (SAS) and an output signal of a forward camera sensor transferred through, e.g., a control area network (CAN). An index calculator 12 calculates a quantitative index to identify a vehicle state based on the sensed signal of the steering angle sensor and an output signal of the forward camera sensor. A data storage unit 13 stores signals provided from the steering angle sensor and the forward camera sensor over a plurality of cyclic time periods, accumulates values calculated by the index calculator 12 and manages the accumulated values as standard values. A statistical processor 14 statistically processes the value calculated by the index calculator 12 and outputs state information which is an index for determining the driver's concentration level.

Although the driver's concentration level determinator 11, the index calculator 12 and the statistical processor 14 may be implemented to be integrated in the controller (e.g., an electronic controller (ECU)), they may alternatively be individually implemented in independent configurations, respectively.

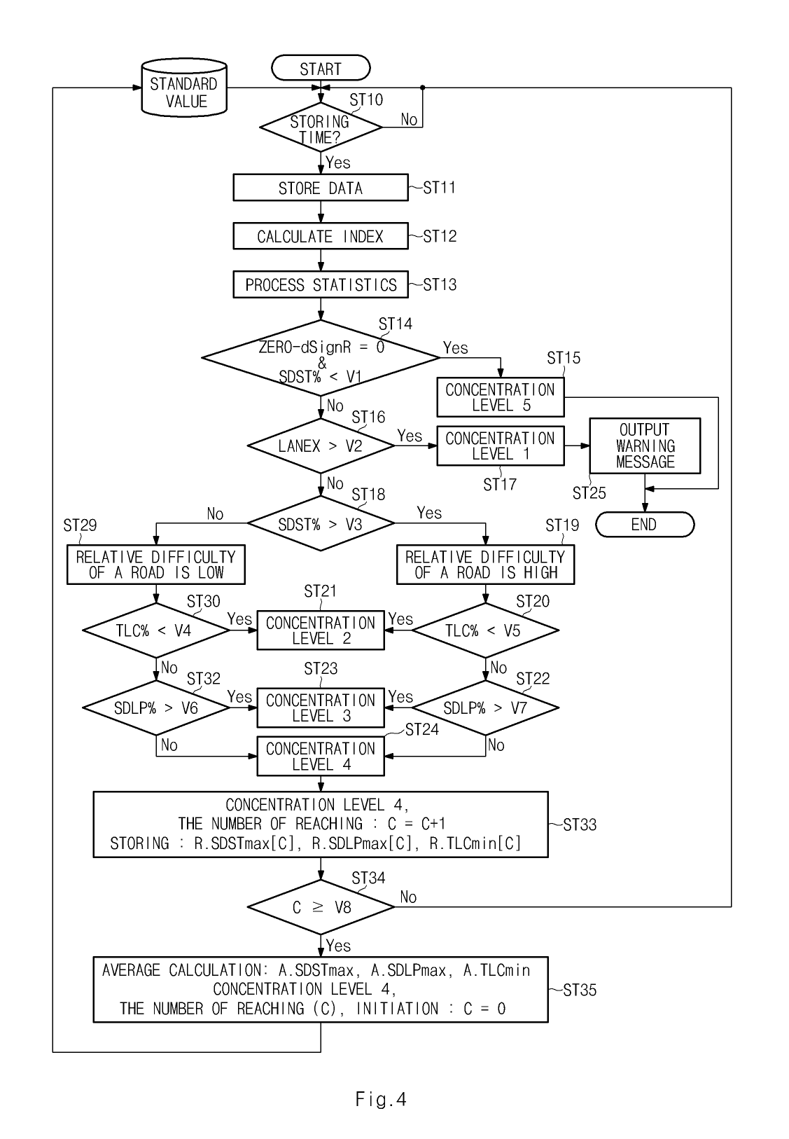

Hereinafter, referring to FIG. 4, a process of calculating the driver's concentration by the Driver's concentration level calculator 20 will be described. Various types of sensors installed in a vehicle sense measured information which is necessary for determining a driving state of the vehicle and transmit the information through the CAN.

The driver's concentration level determinator 11 stores data measured through the SAS and the forward camera sensor to the data storage unit 13 periodically (e.g., every 10 or 30 minutes) (ST10˜ST11), and controls the index calculator 12 so that the index value is calculated at regular intervals according to a predetermined algorithm (ST12). The index value calculated by the index calculator 12 includes a mean lateral position (MLP), a standard deviation of lateral position (SDLP), the number of lane exceedances (LANEX), a time to line crossing (TLC) and the like.

The index calculated by the above-mentioned process is processed into the state information which is used by the illustrative embodiment of the present invention as a guide for determining the driver's concentration level via the statistical processor 14, and is transferred to the driver's concentration level determinator 11 (ST13).

A statically processed result may include a standard deviation of a steering angle of a steering wheel (SDST), a maximum value of SDST (SDSTmax), an increase/decrease rate (SDST %) of a maximum value (SDSTmax) measured for a standard value of SDST (SDSTmax_s), an SDST of a steering wheel, a maximum value of SDLP (SDLPmax), an increase/decrease rate (SDLP %) of a maximum value (SDLPmax) measured for a standard value of SDLP (SDLPmax_s), a minimum value (TLCmin) of an expected time (TLC) that it takes for a side surface of a vehicle to reach an adjacent lane, an increase/decrease rate (TLC %) of a minimum value (TLCmin) measured for a standard value (TLCmin_s) of TLC, and the number of sign variations of an steering angle (ZERO), and the number of sign variations of road curvature radius (dSignR).

The driver's concentration level determinator 11 determines the driver's concentration level comparing the state information output from the statistical processor 14 with the reference value. That is, when the difference between the number of sign variations of the steering angle (ZERO) and the number of sign variations of road curvature radius (dSignR) is less than “0” (that is, ZERO−dSignR=0) and the value of SDST % is less than a predetermined value (V1) (ST14), the concentration level of a driver is determined as level 5 which is a very high level (ST15). The reason for the determination is that lateral position stability of the vehicle is ideal. When it coincides with the condition at the step ST14, it is determined whether the number of lane exceedances (LANEX) exceeds a predetermined value (V2) (ST16).

For reference, the reference values (V1˜V7) including the predetermined values V1 and V2 which will be mentioned below are experientially obtained through repeated actual executions. When a value of the LANEX exceeds the predetermined value (V2) at the step ST16, the driver's concentration level determinator 11 determines that the driver's concentration level is level 1 which is a very low level (ST17). The reason for the determination is that the lateral position of the vehicle has begun to depart a lane slowly. At this time, a warning message may be output (ST25). For example, if the lane departure is for a duration of 0.5 seconds or less, and the vehicle immediately returns to a normal position, it is determined that a collision occurring probability is not high. If a calculation period is set as 10 ms, V2 is suitable at 50 degrees.

When, however, the driver's concentration level cannot be classified into a very high concentration or a very low concentration, a procedure for dividing concentrations of middle levels is performed.

In situations where there is a significant variation in a roads curvature radius or abruptly reducing a speed, coping appearances may be different even under the same road conditions. Thus, when the system does not consider the relative difficulty of a road, an error may occur in a detailed concentration analyzing procedure.

Considering the above—, if a value of LANEX is V2 or less at the step ST16, the driver's concentration level determinator 11 determines whether a value of SDST % exceeds the predetermined value V3 (ST18). For example, a standard deviation of a lateral position of a vehicle is certainly increased on a curved road in comparison with a straight road. Further, a standard deviation of a lateral position of a vehicle is certainly increased at the same curvature radius when a driver is not familiar with a road or it is difficult for the driver to adapt to a specific road's curvatures. Therefore, after classifying the relative difficulty of a road, the driver's concentration is calculated in consideration of the road's degree of difficulty as well. Furthermore, as stated above mid-level concentration levels may be further identified.

For example, if SDS %>V3 at the step ST18, the driver's concentration level determinator 11 determines that the degree of road difficulty is high (ST19). If TLC %<V5, comparing the value of TLC % with a reference value (V5), the driver's concentration level is determined to be level 2 (ST21). Meanwhile, when a value of TLC % is the reference value V5 or more at the step 20, the driver's concentration level determinator 11 compares a value of SDLP % with the reference value V7 (ST22).

As the comparison result, the driver's concentration level is determined as Level 3 when SDLP %>V7 (ST23). The driver's concentration level is determined as Level 4 when SDLP % is V7 or less (ST24). On the contrary, when SDST % is V3 or less at the step 18, the driver's concentration level determinator 11 determines that the difficulty of the road is a low level (ST29). Then, the driver's concentration level determinator 11 compares TLC % with the reference value V4, and when TLC %<V4, the driver's concentration level determinator 11 determines that the driver's concentration level is Level 2 (ST21).

If the value of TLC % is the reference value V4 or more, the driver's concentration level is determined to be Level 2 (ST32). As the comparison result at the step ST32, when SDLP %>V6, the driver's concentration level is determined as Level 3 (ST23), and when SDLP % is V6 or less, the driver's concentration level is determined as Level 4 (ST24).

Meanwhile, the driver's concentration level determinator 11 counters how many times C the driver's concentration level reaches Level 4, and determines whether the number C is the predetermined reference value V8 or more (ST34).

As the determination result at the step ST34, if C≧V8, a standard value which is the comparing reference is updated with the average value of SDSTmax, SDLPmax and TLCmin, and by initiating the value C, the process of one cycle for determining the driver's concentration level is completed (ST35).

According to the embodiment, it is possible to calculate a driver's concentration level using a steering wheel steering angle sensor and a forward camera sensor mounted on a vehicle during manufacturing to classify the driver's concentration level into several levels according to a situation and state, and provide the difficulty of a road on which the vehicle is traveling that indicates an individual deviation according to driving ability of a driver.

Furthermore, although there is a default reference value which may be used initially upon delivery of a vehicle to a consumer, a daily state determination value of an individual is analyzed through continued concentration level determination according to the present invention, and by resetting the reference value with default, concentration level differences between drivers may be compensated.

According to another embodiment of the present invention, without implementing the driver's concentration level calculator 20, the present invention may include a driver's concentration level information collector (not shown in drawings) which is operatively associated with a driver drowsiness determining system which determines the driver drowsiness through image recognition well known in the art, a driver's concentration informing system which determines a driver's level of carelessness when a driver talks beyond a threshold time by recognizing a driver's voice.

In this case, when the driver's concentration level information collector collects driver's concentration level information, the controller 30 controls the LKAS driver 40 based on a reference steering angle which is narrow, such as the reference numeral ‘220’ in FIG. 2. In this case, it is determined that the driver's concentration level is low since the driver is dozing or having a prolonged conversation.

Further, when the driver's concentration level information collector does not collect driver's concentration level information, the controller 30 controls the LKAS driver 40 based on a reference steering angle which is wide, such as the reference numeral ‘210’ in FIG. 2. In this case, it is determined that the driver's concentration level is high since the driver is concentrating on driving.

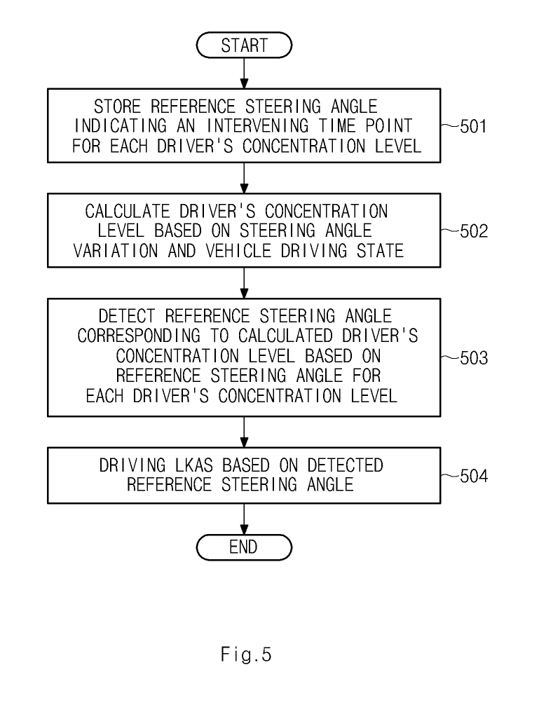

FIG. 5 is a flowchart for explaining a method for controlling lane maintenance based on a driver's concentration level according to an embodiment of the present invention. First, the reference steering angle memory 10 stores reference steering angles which indicates when to allow the LKAS to intervene for each driver's concentration level (501). Then, the driver's concentration level calculator 20 calculates the driver's concentration level based on a variation of a steering angle and a driven state of a vehicle (502). Then, the controller 30 detects a reference steering angle corresponding to a driver's concentration level calculated by the calculator 20 based on the reference steering angles for each driver's concentration level stored in the memory 10 (503). Then, the LKAS driver 40 drives the LKAS based on the detected reference steering angle (504).

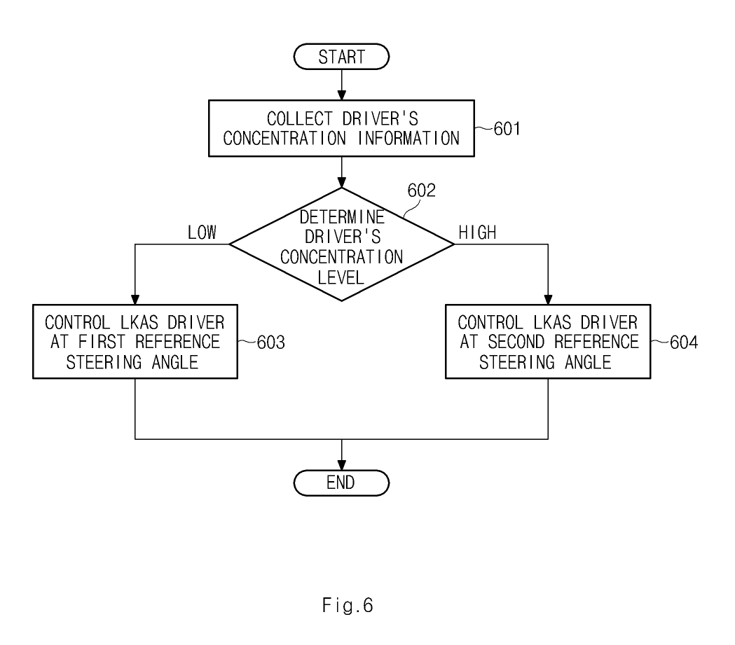

FIG. 6 is a flowchart for explaining a method for controlling lane maintenance based on a driver's concentration level according to another embodiment of the present invention. First, the driver's concentration level information collector collects driver's concentration information of a driver (601). Then, the controller 30 determines a driver's concentration level through whether or not the driver's concentration level information collector collects the driver's concentration information of the driver (602). As the determination result (602), if the driver's concentration level information collector collects the driver's concentration information of the driver, the controller 30 determines that the driver's concentration level of the driver is low, such that it controls the LKAS driver 40 at the first steering angle which is narrow (603). As the determination result (602), if the driver's concentration level information collector does not collect the driver's concentration information of the driver, the controller 30 determines that the driver's concentration level of the driver is high, such that it controls the LKAS driver 40 at the second steering angle which is wide (604). Therefore, the LKAS driver 40 drives the LKAS based on either the first or second reference steering angle from the controller 30.

Furthermore, the control logic of the present invention may be embodied as non-transitory computer readable media on a computer readable medium containing executable program instructions executed by a processor, controller or the like. Examples of the computer readable mediums include, but are not limited to, ROM, RAM, compact disc (CD)-ROMs, magnetic tapes, floppy disks, flash drives, smart cards and optical data storage devices. The computer readable recording medium can also be distributed in network coupled computer systems so that the computer readable media is stored and executed in a distributed fashion, e.g., by a telematics server or a Controller Area Network (CAN).

Although exemplary embodiments of the present invention have been described in detail hereinabove, it should be clearly understood that many variations and modifications of the basic inventive concepts herein taught which may appear to those skilled in the present art will still fall within the spirit and scope of the present invention, as defined in the appended claims.

What is claimed is:

1. An apparatus for controlling lane maintenance based on a driver's concentration level, the apparatus comprising:
a memory configured to store reference steering angles for each of driver's concentration levels, each of the reference steering angles indicating time points at that a lane keeping assist system (LKAS) intervenes in driving;
a calculator configured to calculate a concentration level of a driver based on a variation in a steering angle and a driving state of a vehicle;
a controller configured to detect a reference steering angle corresponding to a calculated concentration level from the calculator based on the reference steering angles for each driver's concentration level stored in the memory, and to control an LKAS driver based on a detected reference steering angle; and
the LKAS driver driving the LKAS based on the detected reference steering angle from the controller.

2. The apparatus of claim 1, wherein when a driver's concentration level of a level 3 has a first reference steering angle, one driver's concentration level which has a higher level than the level 3 has a greater angle than the first reference steering angle, and another driver's concentration level which has a lower level than the level 3 has an angle less than the first reference steering angle.

3. The apparatus of claim 1, wherein the calculator calculates an index which is used to determine the driver's concentration level, based on the variation of the steering angle while driving the vehicle and information about the driving state of the vehicle is obtained through a front camera sensor, and converts a calculation result into statistical information to calculate the driver's concentration level.

4. An apparatus for controlling lane maintenance based on a driver's concentration level, the apparatus comprising:
a driver's concentration information collector configured to collect information about a driver's concentration level of a driver;
a controller configured to control a lane keeping assist system (LKAS) driver at a first reference steering angle by determining that the driver's concentration level of the driver is low when the driver's concentration information collector collects the driver's concentration level of the driver, and to control the LKAS driver at a second reference steering angle by determining that the driver's concentration level is high when the driver's concentration information collector does not collect the driver's concentration level of the driver; and
the LKAS driver for driving an LKAS based on either the first or second reference steering angle from the controller.

5. The apparatus of claim 4, wherein the driver's concentration information collector collects the information about the driver's concentration level in cooperation with a driver drowsiness determination system or a driver's concentration level informing system of external.

6. A method for controlling lane maintenance based on a driver's concentration level, the method comprising:
storing, within a memory, reference steering angles for each driver's concentration level by a reference steering angle memory, each of the reference steering angle indicating time points that a lane keeping assist system (LKAS) intervenes in driving;
calculating, by a calculator, a concentration level of a driver based on a variation of a steering angle and a driving state of a vehicle;
detecting, by a controller, a reference steering angle corresponds to a calculated concentration level based on the reference steering angles corresponding to each of the stored driver's concentration levels; and
driving, by an LKAS driver, the LKAS based on the detected reference steering angle.

7. The method of claim 6, wherein when a driver's concentration level of a level 3 has a first reference steering angle, one driver's concentration level which has a higher level than the level 3 has a greater angle than the first reference steering angle, and another driver's concentration level which has a lower level than the level 3 has an angle less than the first reference steering angle.

8. The method of claim 6, wherein calculating the concentration level of the driver based on the variation of the steering angle and the driving state of a vehicle by a driver's concentration level calculator comprises:
calculating an index which is used for determining the driver's concentration level, based on the variation of the steering angle while driving the vehicle and information about the driven state of the vehicle obtained through a front camera sensor; and
converting a calculation result into statistical information to calculate the driver's concentration level.

9. A method for controlling lane maintenance based on a driver's concentration level, the method comprising:
collecting, by a collector, information about a concentration level of a driver;
controlling, by a controller, a lane keeping assist system (LKAS) driver at a first reference steering angle by determining that the driver's concentration level is low when the collector collects the concentration level of the driver;
controlling, by the controller, the LKAS driver at a second reference steering angle by determining that the driver's concentration level of the driver is high when the collector does not collect the concentration level of the driver; and
driving an LKAS based on either the first or second reference steering angle from the controller by the LKAS driver.

10. The method of claim 9, wherein collecting information about the concentration level of the driver by the collector collects the information about the driver's concentration level in cooperation with a driver drowsiness determination system or a driver's concentration level informing system of external.
